(19) United States
(12) Patent Application Publication
(10) Pub. No.: US 2017/0144764 A1
(43) Pub. Date: May 25, 2017

(54) INTEGRATED AIRCRAFT SEAT AND SIDEWALL

(71) Applicant: The Boeing Company, Chicago, IL (US)

(72) Inventors: BRYAN D. MORAN, Mukilteo, WA (US); JONATHAN R. WIGHTMAN, Everett, WA (US)

(21) Appl. No.: 14/949,081

(22) Filed: Nov. 23, 2015

(51) Int. Cl. B64D 11/06

(52) U.S. Cl. CPC B64D 11/0606; B64D 11/0605; B64D 2011/0038

(57) ABSTRACT

A modular suite 10 is disclosed. Embodiments of the modular suite 10 may provide a suite base 12 to which a seat wall 14, a footrest wall 16, and a sidewall 18 (collectively, “suite walls”) may be mounted. Suite 10 may be installed within an aircraft by securing it to the aircraft passenger floor. Embodiments with suites 10 installed along fuselage walls are spaced to have a gap between the outside surface of the sidewall 18 and the inner surface of the fuselage wall (sometimes called the fuselage inner mould layer (IML)). Thus, the sidewall 18 floats relative to the fuselage frame.

### FIELD OF THE DISCLOSURE

This disclosure relates to seating suites for aircraft. In particular, the disclosure relates to a seating suite with integral, floating walls.

### BACKGROUND

Typically, commercial aircraft interiors are modifiable with the sidewalls. That is, aircraft interior manufacturers are essentially free to design custom interiors on an aircraft delivered with standard sidewalls already installed. This is because sidewalls are typically attached to the aircraft frame and serve several important functions that should not be disrupted, including, covering systems such as insulation, closing out window coverings, venting airflow to and from the passenger deck or decks. Sidewalls are typically thought of as non-modifiable in most cases because they are so strategically designed that a redesign for mere aesthetics would have little benefit in view of the costs and complications. Moreover, sidewalls have traditionally been attached to the fuselage frame due to its proximity to the sidewall, so it has seemed undesirable to re-engineer sidewalls for tailored interior passenger experiences. Other drawbacks and disadvantages of typical aircraft seating suites also exist.

### SUMMARY

Accordingly, the disclosed systems and methods address some of the above-noted and other drawbacks and disadvantages of existing systems and methods.

In addition, embodiments of the disclosed suite mount to the aircraft passenger floor, as past suites do, but includes an integrated sidewall. Thus, the sidewall floats relative to the fuselage frames—a departure from what has been done before. As discussed above, typically, aircraft manufacturers want the sidewall attached to the fuselage frame and the suite attached to the floor so that there could be relative motion between the two components during movement and flexing of the airplane.

One advantage of the disclosed systems and methods is that the aircraft interior is easier to customize with more options for ornamental covering for the windows such as the “leaf” or “feather” window covering design shown in the present figures and shown in co-pending design patent application Ser. No. ______, filed ______, and titled “Ornamental Design For A Seating Suite Window,” which is incorporated in its entirety herein by reference.

Another advantage of disclosed embodiments, are they give a more integrated look-and-feel to the seating suite. Still another advantage, is that the modular suite is typically easier to install. Still another advantage is that the suite can be lighter because it can be customized without having multiple layers of sidewalls.

In addition, lighting systems and any other systems may span from the suite into the sidewall. Moreover, retrofitting and updating interiors is easier as it is much easier to work with attaching to seat track fittings rather than sidewall fittings, which are cumbersome. Other advantages and features of disclosed systems and methods may also exist.

Accordingly, disclosed embodiments include a seating suite for an aircraft comprising a base, a sidewall attached to the base, a seat wall attached to the base, and wherein when the seating suite is installed in an aircraft an outer surface of the sidewall is proximate to an inner surface of a fuselage wall of the aircraft with a gap there between. Embodiments may also include a window opening in the sidewall. The window opening may span more than one window port in the fuselage wall.

Embodiments may also include a footrest wall attached to the base, and a front wall attached to the base. In some embodiments, the front wall comprises an opening for occupant ingress and egress.

Disclosed embodiments may also include a valance spanning at least a portion of at least one of the sidewall or the seat wall. In some embodiments, a lighting system may be mounted in at least a portion of the valance.

Disclosed embodiments may also include a beveled surface in at least a portion of the sidewall. In some embodiments, a lighting system may be mounted in at least a portion of the beveled surface.

Also disclosed is a method of installing a seating suite comprising installing a sidewall on a base, installing a seat wall on the base, installing the base on a floor of an aircraft, and wherein when installed an outer surface of the sidewall is proximate to an inner surface of a fuselage wall with a gap there between.

Disclosed methods may also include providing a window opening in the sidewall. Disclosed methods may also include installing the base on the floor of an aircraft so that the window opening spans more than one window port in the fuselage wall.

Disclosed methods also include installing a footrest wall on the base, and installing a front wall on the base. In some embodiments the front wall comprises an opening for occupant ingress and egress.

Disclosed methods may also include providing a valance spanning at least a portion of at least one of the sidewall or the seat wall. Disclosed methods may also include mounting a lighting system in at least a portion of the valance.

Disclosed methods may also include providing a beveled surface in at least a portion of the sidewall. Disclosed methods may also include mounting a lighting system in at least a portion of the beveled surface. Other embodiments and methods are also possible.

### BRIEF DESCRIPTION OF THE DRAWINGS

FIG. 1 is an isometric perspective front view of a modular suite in accordance with disclosed embodiments.

FIG. 2 is an isometric perspective front view of a modular suite in accordance with disclosed embodiments.

FIG. 3 is a side view of a modular suite in accordance with disclosed embodiments.

FIG. 4 is a top-down perspective view of a modular suite in accordance with disclosed embodiments.

FIG. 5 is a top-down perspective view of a plurality of modular suites in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

As shown in the figures, a modular suite 10 is disclosed. Embodiments of the modular suite 10 may comprise a suite base 12 to which a seat wall 14, a footrest wall 16, and a sidewall 18 (collectively, “suite walls”) may be mounted. The mounting of the suite walls may be accomplished in any suitable manner. For example, the suite base and suite walls may be bolted, screwed, nailed, welded, frictionally fit, interlocked, integrally molded, or the like. Further, while footrest wall 16 and seat wall 14 are shown, respectively, as adjacent a footrest 20 and seat 22, the disclosure is not so limited and other seat configurations are possible. For example, additional seats 22 may be included in the suite, or the like. For consistency and convenience, seat wall 14 and footrest wall 16 will be referred to as such even though the respective seat 22 and footrest 20 need not be included in the suite 10.

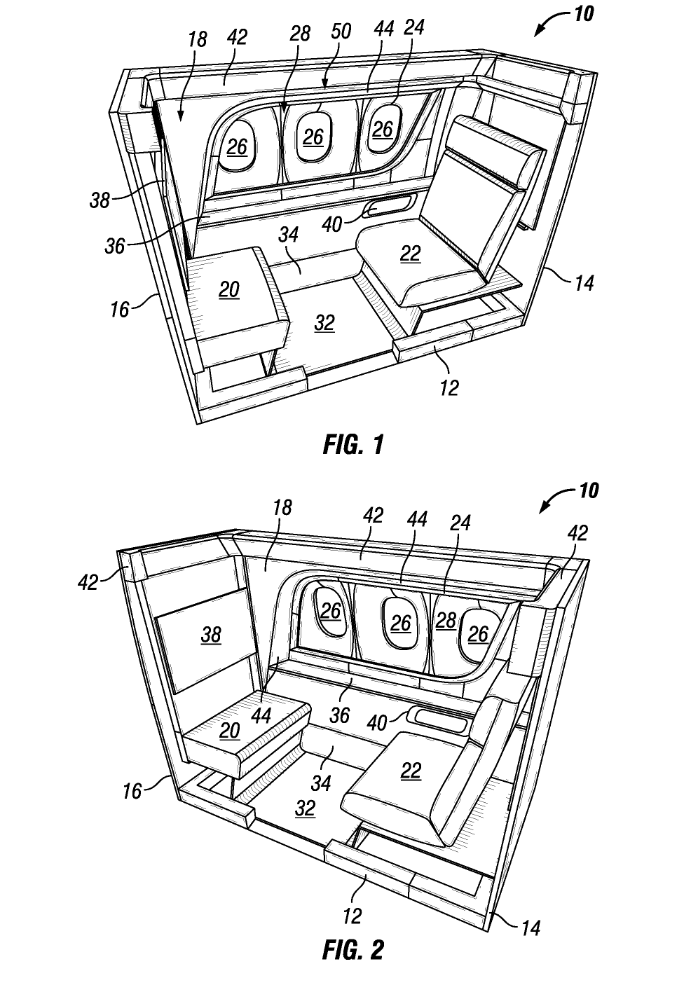

As shown, embodiments of suite 10 may also comprise a window opening 24. Window opening 24 may span one or more of the window ports 26 in the fuselage wall 28 of the aircraft. For the embodiments shown in FIGS. 1-2, window opening 24 spans three window ports 26. The shape of window opening 24 is also variable. For example, window opening 24 may be shaped as the “leaf” or “feather” window opening 24 shown in the present figures and shown in co-pending design patent application Ser. No. ______, filed ______, and titled “Ornamental Design For A Seating Suite Window,” which is incorporated in its entirety herein by reference.

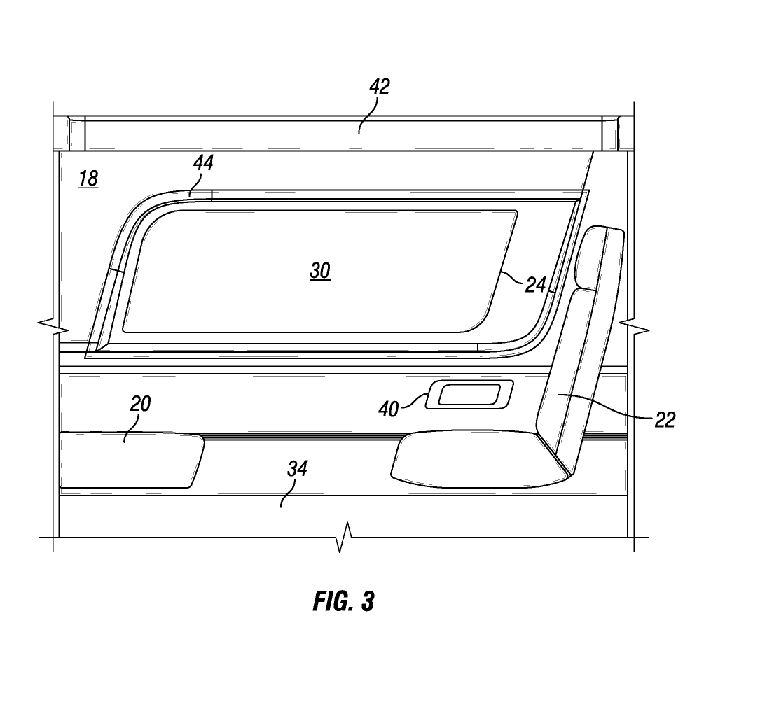

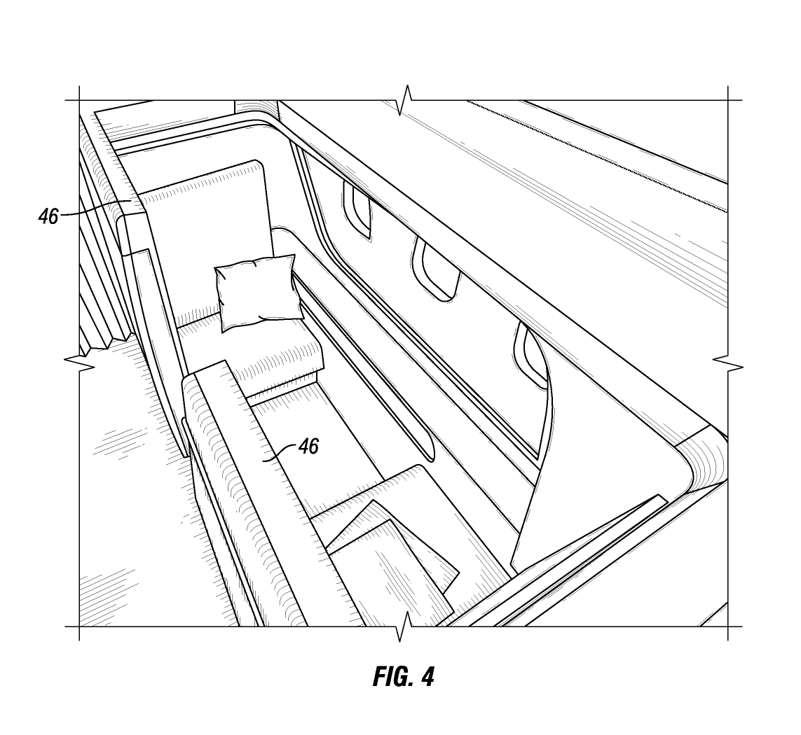

In some embodiments, window opening 24 may be open to the fuselage wall 28. In other embodiments, it may be desirable to include a transparent cover (e.g., glass, Plexiglas, plastic, or the like) in the window opening 24, the cover may be clear, tinted, or otherwise colored. In some embodiments, window opening 24 may include electrically tinting glass and may allow the occupant to control the tint level. As shown in FIG. 3, window opening 24 may also comprise a window shade 30 that the occupant may raise or lower as desired. In some embodiments shade 30 may be manually operable, in other embodiments, shade 30 may be electromechanically operable. Other embodiments are also possible.

As also shown, suite 10 may comprise a floor area 32, one or more baseboards 34, one or more shelves 36, an information and entertainment display 38, and a control panel 40. In some embodiments, one or more of the floor area 32 and baseboard 34 may be carpeted or otherwise textured. In some embodiments, control panel 40 may be removable and hand-held and may control one or more of the information and entertainment display 38, seat 22, footrest 20, window shade 30, lighting, and air conditioning. Other systems may also be controlled via control panel 40. As also shown in FIG. 1, in some embodiments control panel 40 may be ornamented with a shape similar to, or substantially the same as, the shape of window opening 24.

As also shown, suite 10 may comprise a valance 42 and one or more beveled surfaces 44. In some embodiments, valance 42 may span the entire top edge of the suite 10 and may be used to at least partially conceal lighting systems 50, environmental systems (e.g., air conditioning, heating, or the like). Similarly, in some embodiments, one or more of the beveled surfaces 44 may contain lighting 50, environmental systems, or the like. Likewise, valance 42 and beveled surfaces 44 may have ornamental designs compatible with, or substantially similar to, that of window opening 24.

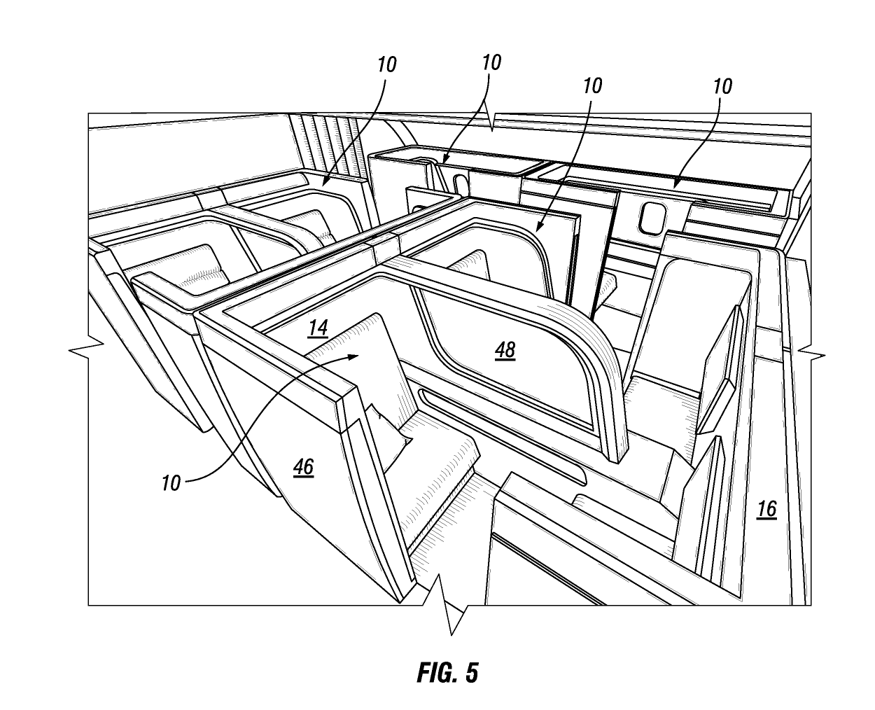

As shown in FIG. 4, embodiments of suite 10 may also comprise a front wall 46. Front wall 46 may contain an opening, a door (not shown), or a slideable portion if the occupant desires additional privacy. Other configurations are also possible.

As shown in FIG. 5, the suite 10 may be modified for interior (i.e., windowless) seats. As shown, the suite may comprise an interior divider wall 48 that separates two or more suites 10. In some embodiments, divider wall 48 may extend partially through the suite 10. In other embodiments, divider wall 48 may extend completely through the suite and intersect both the seat wall 14 and the footrest wall 16.

As should be apparent, modular suite 10 may be constructed in any appropriate fashion. For example, seat wall 14, footrest wall 16, sidewall 18, and, optionally, front wall 46, or divider wall 48) may be fastened to suite base 12, and to each other. Then seat 22, footrest 20, window shade 30, baseboard 34, shelf 36, information and entertainment display 38, control panel 40, valance 42, beveled surfaces 44, and any other ornamental or comfort systems may be installed within suite 10. Then, suite 10 may be installed within an aircraft by securing it to the aircraft passenger floor. As shown in FIGS. 4-5, any number of suites 10 may be installed on the aircraft floor depending on the size of the aircraft, the number of suites 10 desired, or the like.

In any case, and no matter the number of suites 10 installed, they may be installed without the need to attach the suite 10 to the fuselage wall of the aircraft. Embodiments with suites 10 installed along fuselage walls are spaced to have a gap between the outside surface of the sidewall 18 and the inner surface of the fuselage wall (sometimes called the fuselage inner mould layer (IML)). Thus, the sidewall 18 floats relative to the fuselage frame.

Although various embodiments have been shown and described, the present disclosure is not so limited and will be understood to include all such modifications and variations are would be apparent to one skilled in the art.

What is claimed is:

1. A seating suite for an aircraft comprising:
a base;
a sidewall attached to the base;
a seat wall attached to the base; and
wherein when the seating suite is installed in an aircraft an outer surface of the sidewall is proximate to an inner surface of a fuselage wall of the aircraft with a gap there between.

2. The seating suite of claim 1 further comprising:
a window opening in the sidewall.

3. The seating suite of claim 2 wherein the window opening spans more than one window port in the fuselage wall.

4. The seating suite of claim 1 further comprising:
a footrest wall attached to the base.

5. The seating suite of claim 1 further comprising:
a front wall attached to the base; and wherein the front wall comprises an opening for occupant ingress and egress.

6. The seating suite of claim 1 further comprising:
a valance spanning at least a portion of at least one of the sidewall or the seat wall.

7. The seating suite of claim 6 further comprising:
a lighting system mounted in at least a portion of the valance.

8. The seating suite of claim 1 further comprising:
a beveled surface in at least a portion of the sidewall.

9. The seating suite of claim 8 further comprising:
a lighting system mounted in at least a portion of the beveled surface.

10. A method of installing a seating suite comprising:
installing a sidewall on a base;
installing a seat wall on the base;
installing the base on a floor of an aircraft; and
wherein when installed an outer surface of the sidewall is proximate to an inner surface of a fuselage wall with a gap there between.

11. The method of claim 10 further comprising:
providing a window opening in the sidewall.

12. The method of claim 11 further comprising:
installing the base on the floor of an aircraft so that the window opening spans more than one window port in the fuselage wall.

13. The method claim 10 further comprising:
installing a footrest wall on the base.

14. The seating suite of claim 10 further comprising:
installing a front wall on the base; and wherein the front wall comprises an opening for occupant ingress and egress.

15. The method of claim 10 further comprising:
providing a valance spanning at least a portion of at least one of the sidewall or the seat wall.

16. The method of claim 15 further comprising:
mounting a lighting system in at least a portion of the valance.

17. The method of claim 10 further comprising:
providing a beveled surface in at least a portion of the sidewall.

18. The method of claim 17 further comprising:
mounting a lighting system in at least a portion of the beveled surface.
